(19) United States
(12) Patent Application Publication
(10) Pub. No.: US 2007/0105569 A1
(43) Pub. Date: May 10, 2007

(54) Short message for voice group call service

(75) Inventors: Volker Brass, Bonn (DE); Walter Grethe, Koln (DE); Thomas Sieredzki, Bonn (DE)

Correspondence Address: NORRIS, MCLAUGHLIN & MARCUS, 875 THIRD AVE, 18TH FLOOR, NEW YORK, NY, 10022, US

(73) Assignee: T-MOBILE DEUTSCHLAND GMBH, Bonn (DE)

(21) Appl. No.: 10/579,321

(22) PCT Filed: Nov. 19, 2004
(86) PCT No.: PCT/EP04/13158

§ 371 Date: Jan. 8, 2007

(30) Foreign Application Priority Data
Nov. 21, 2003 (EP) 03026785.0

(51) Int. Cl. H04Q 7/20

(52) U.S. Cl. 455/466; 455/518; 455/428

(57) ABSTRACT

Disclosed is a method for transmitting text- and/or binary information in form of a short message in addition to voice information for a talker and at least one listener of a Voice Group Call, by sending a special, dedicated signal to all listeners and to the talker. The text- and/or binary message can be sent and received simultaneous to an ongoing group call.

The present invention generally relates to the field of voice group services in mobile communication networks, and in particular to Voice Group Call Services (VGCS).

Voice Group Call Service is a call that can be established between members of a group in numerous cells of the mobile telecommunication network simultaneously. These cells define the service area. All subscribers belonging to the group have the possibility to listen to the call in the service area. It is also possible to participate in the call individually. Service subscribers of the radio network can become group members on a network wide basis to one or more groups pre-defined in the network by a corresponding group identification (group ID). The membership enables them to receive voice group calls associated with that group ID. In addition, certain group members are entitled by their subscription to initiate Voice Group Calls (VGC). In addition to subscriber details in the Home Location Register (HLR), it is necessary for the mobile station (MS) to be aware of its group membership by storing details on the Subscriber Identity Module (SIM). This is required because it responds to notification messages which include only the group call relevant information,(i.e. no IMSI or TMSI details). Having become a group member, each service subscriber can set to active state or deactive state the group ID or any one out of his several group IDs on the SIM. In active state the subscriber can initiate VGCs to that group ID. When in deactive state the subscriber can not make VGCs to the group and the mobile station ignores any notification for that group ID.

A group call area can be restricted to a single Mobile Switching Center (MSC) area or can exceed one MSC area (implementation option). A voice group call is initiated by a calling subscriber by a related man machine interface action for the service selection and the group ID dialled. The MSC in which the voice group call is initiated obtains by requesting a Group Call Register GCR the group call attributes. The GCR is a functionality in the network containing the group call attributes. This GCR interrogation after call initiation also determines whether the MSC acts as group call Anchor- or as group call Relay-MSC. A group call Anchor-MSC is responsible for managing and maintaining a particular VGC. The group call Anchor-MSC is determined as the one controlling the cells of the group call area. For VGCSs where the group call area exceeds an MSC area, the group call Anchor-MSC is predefined in the network. A group call Relay-MSC controls cells of a group call area which are not under control of the group call Anchor-MSC for those voice group call services where the group call area exceeds one MSC area.

If the MSC is not the Anchor-MSC then the call will be “forwarded” from the Relay-MSC to the respective Anchor-MSC (information also delivered by GCR) and further “call-establishment” is done by the Anchor-MSC.

When a calling subscriber (talker) initiates a voice group call, one voice group call channel is established in each cell of the group call area and notifications for that call is sent in each of these cells. A voice group call channel is a downlink to be allocated in each cell of the group call area for a particular voice group call. All mobile stations (listeners) being service subscribers for that Voice Group Call in one cell listen to the common downlink. of course it is possible to change the talker at any time, so that one of the listeners of the group becomes the talker and the previous talker becomes a listener.

It is the object of the invention to enhance the conventional voice group call service by providing an additional communication service.

This object is achieved by providing a method and a communication system as disclosed in the independent claims.

Other features which are considered to be characteristic for the invention are set forth in the appended claims.

The short message (SM) for voice group call service according to the present invention is designed to provide all listeners of a voice group call with additional text-or binary-information via short message service. Preferably this is done by sending a short message mobile terminated (SM MT) to all listeners and to the talker of the group, preferably in unacknowledged mode.

The text- and/or binary message can be sent and received simultaneous to an ongoing group call.

The receiving of the SM by group members currently not partaking in the listener mode or talker mode, but subscribed for the ongoing VGC is not supported by this feature.

The SM for VGCS follows the structure of a normal Point-to-Point-SMS (PtP-SMS) in parallel to an ongoing PtP-voice- or PtP-cs-data-call as currently standardised by 3GPP as most as possible.

In addition of providing the receiving of a SM (SM MT) it is also possible to provide the sending of a SM from the current talker to the network as short message mobile originated (SM MO). Here it may be a further option to the send this SM in acknowledged mode.

The receiving of the SM by group members currently not partaking in the listener mode or talker mode, but subscribed for the ongoing VGS is not supported by this feature.

The SMS will be addressed by the associated Voice Group Call REFERENCE. The group call reference is a concatenated sequence of the group ID (as the least significant part) and the group call area ID (as the most significant part).

Further options:
a) If the current talker is sending a SM and during the sending the talker intends to end his speaking, it is necessary that the MS will hold the uplink until the SM is sent completely to the network. This may cause pauses in the conversation (in the case that other MS are requesting the uplink).
b) Sending and Receiving of a SM in parallel to a ongoing voice group call will be unacknowledged. It may be an further option to acknowledge the SM sent by the current talker by the network. In this case it has to be solved if the network acknowledge a SMS and MS which has sent the SMS is not the current talker any more.
c) There is no interaction with GPRS and SM for this feature.

In the following the invention will be described in with reference to the appended drawings.

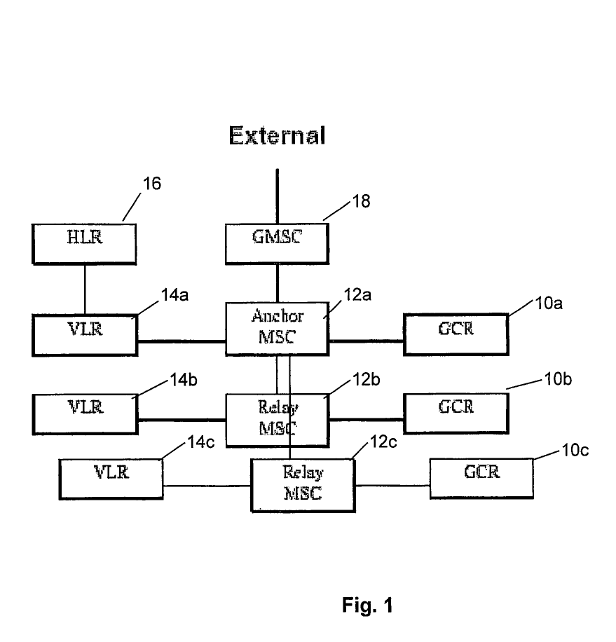

FIG. 1: Functional voice group call architecture with a group call register.

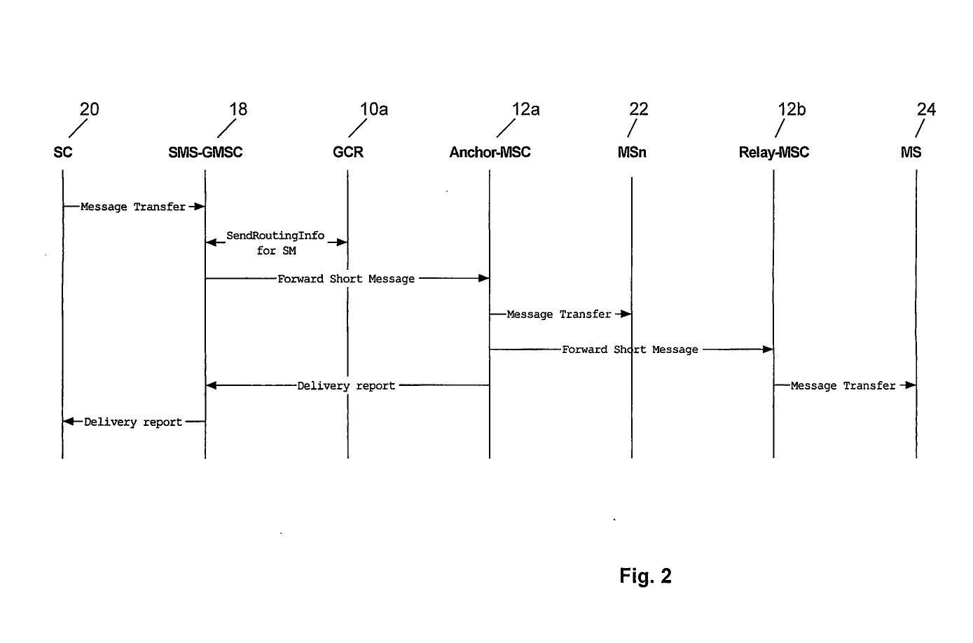

FIG. 2: Transfer of a SM to members of a VGCS.

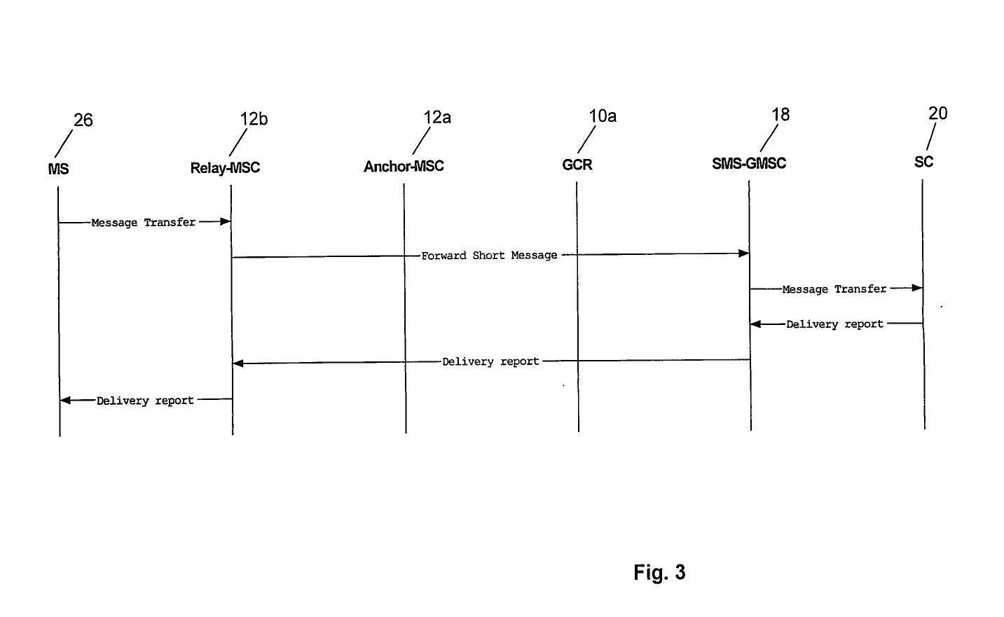

FIG. 3: Transfer of a SM from the current talker of a VGCS.

The general architecture of GSM is maintained. In addition, a network function is required which is used for registration of the group call attributes, the group call register (GCR) 10a, 10b, 10c. The GCR function is mainly a database function, holding information about voice group calls. The signalling between the entities shown in FIG. 1 shall be as defined in the following.

The Mobile Switching Center (MSC) 12a, 12b, 12c containing the cell within which this voice group call is initiated performs subscription checking against Visitor Location Register (VLR) 14a, 14b, 14c and Home Location Register 16 records. It then consults its GCR 10a, 10b, 10c, respectively, to determine the group call attributes related to its MSC area and whether it is the group call Anchor-MSC 12a for that voice group call. If it is not, the GCR provides with the group call reference and the routing information identifying the group call Anchor-MSC 12a to the originating MSC. The originating MSC then routes the voice group call to the Anchor-MSC 12a. If the originating MSC is the group call Anchor-MSC 12a, along with the group call attributes, the respective GCR 10a provides information on all group call Relay-MSCs 12b, 12c to be involved. The group call Anchor-MSC 12a sets up links to all group call Relay-MSCs 12b, 12c. Each MSC 12a, 12b, 12c involved in a voice group call obtains its proper group call attributes from the GCR 10a, 10b, 10c related to the respective MSC.

The GCR 10a, 10b, 10c holds for a related MSC area for each group ID and cells from which voice group calls can be established by service subscribers the group call reference to be used for a voice group call to be established and an indication whether the originating MSC is the group call Anchor-MSC 12a. If the originating MSC is the group call Anchor-MSC 12a, the GCR 10a provides the group call attributes related to that group call reference to the originating MSC and the originating MSC establishes the voice group call. If the originating MSC is not the Anchor-MSC 12a, the GCR 10a provides the group call reference plus the routing information identifying the Anchor-MSC 12a to the originating MSC and the originating MSC routes the voice group call to the Anchor-MSC 12a.

FIG. 2 shows the signalling in case that a SME, e.g. a mobile station or a server, in the network requests the short message service center (SC) 20 to send a SM to the members of a VGC, indicated as MSn 22, Msm 24. In this case, where the destination of a SM is not a MSISDN, but a VGC-REFERENCE, the SC interrogates the GCR in order to retrieve the routing information of the Anchor-MSC for this VGC. That followed the SC forwards the SM to the appointed Anchor-MSC for this VGC. The Anchor-MSC itself forwards the SM to all BSS partaking in the VGC and in addition to all Relay-MSCs. The Relay-MSCs in turn are responsible to send the SM to all respective BSS for this VGC.

The SM itself is sent on the VGC controlling Signalling Connection Control Part (SCCP) connection (Another solution can be to send the SM on all resource controlling SCCP connections associated to the respective VGC. The BSS is responsible to send this SM on the respective Slow Associated Control Channel (SACCH) of all Traffic Channels (TCHs) where this VGC is established. In this case the SM will not be acknowledged.

A delivery report can be generated by the current talker of the group (not shown in FIG. 2).

As shown in FIG. 3, it is possible that the current talker is able to send a SM. In this case the MS 26 of the current talker will send the SM via the SACCH of the respective uplink-channel on the resource controlling SCCP connection to the MSC 12b analogue to the sending of a PtP-SMS via the respective SACCH. In this case the destination of the SM can be either a MSISDN (or similar for a PtP-SM) or a VGC-REFERENCE. In the first case the SM is forwarded to the SC and there it will be handled according o normal PtP-SM. In the second case the SM is handled as accordingly to the described procedures in this chapter.

In this case an acknowledgement of the SM can be realised. The acknowledgement is sent from the MSC to the BSS on the resource controlling SCCP connection. The acknowledgement of the SM sent from the talker can be realised, independent from the chosen channel-model for VGC.

List of reference numerals and abbreviations

10a, 10b, 10c Group Call Register

12a, 12b, 12c Mobile Switching Center

14a, 14b, 14c Visitor Location Register

16 Home Location Register

18 Gateway Mobile Switching Center

20 Short Message Service Center

22 Mobile Station

24 Mobile Station

26 Mobile Station

GCR Group Call Register

IMSI International Mobile Subscriber Identity

MO Mobile originated

MS Mobile Station

MSC Mobile Switching Center

MT Mobile terminated

PtP Point-to-Point

SACCH Slow Associated Control Channel

SC (Short Message) Service Center

SCCP Signalling Connection Control Part

SM Short Message

SME Short Message Entity

TMSI Temporary Mobile Subcriber Identity

VGC Voice Group Call

VGCS Voice Group Call Service

1. A method for transmitting text- and/or binary information (short message) in addition to voice information for a talker (if present) and at least one listener of a Voice Group Call, comprising the step of sending a special, dedicated signal to all listeners and to the talker.

2. The Method according to claim 1, wherein the message is sent in unacknowledged mode.

3. The method according to claim 1, wherein the special dedicated signal is a short message mobile terminated SM MT.

4. The method according to any of claim 1, wherein the SM follows the structure of a regular PtP-SMS in parallel to an ongoing PtP-voice- or PtP-cs-datacall.

5. The method according to claim 1, wherein the SM is send from the current talker to the network in form of a short message mobile originated SM MO.

6. The method according to claim 5, wherein the SM MO is sent in acknowledged mode.

7. The method according to claim 1, wherein the SM will be addressed by an associated Voice Group Call reference.

8. The method according to any of claim 1, wherein, if the current talker is sending a SM and during the sending the talker intends to end his speaking, the MS will bold the uplink until the SM is sent completely to the network.

9. The method according to any of claim 1, wherein a SME in the network requests the SC to send a SM to the members of a VGC, the SC interrogates the GCR in order to retrieve the routing information of an Anchor-MSC for this VGC, the SC forwards the SM to the appointed Anchor-MSC for this VGC, the Anchor-MSC itself forward the SM to all base station subsystems BSS partaking in the VGC and in addition to all Relay-MSCs, the Relay-MSCs send the SM to all respective BSS for this VGC, which transmit it to the listeners.

10. The method according to claim 1, wherein the current talker sends a SM via a SACCH of the respective uplink-channel on the resource controlling signaling connection control part SCCP to the MSC analogue to the sending of a PtP-SMS via the respective SACCH, where the destination of the SM can be either a MSISDN or a VGC-REFERENCE.

11. The method according to claim 1, wherein, by using the MSISDN the SM is forwarded to the SC and there it is handled according to normal PtP-SM.

12. Method according to claim 1, wherein, by using the VGC-Reference the SM is handled as accordingly the described procedures.

13. A mobile communication system with at least one logical unit for controlling signal exchange between the members of a Voice Call, Group and with additional functional processing means for transmitting text-and/or binary information to one or more users of the Voice Group.

14. A mobile communication system according to claim 13, wherein the text- and/or binary information is a short message SM.
